(19) United States
(12) Patent Application Publication
(10) Pub. No.: US 2022/0030474 A1
(43) Pub. Date: Jan. 27, 2022

(54) COMMUNICATIONS DEVICE, INFRASTRUCTURE EQUIPMENT, CORE NETWORK EQUIPMENT AND METHODS

(71) Applicant: Sony Group Corporation, Tokyo (JP)

(72) Inventors: Vivek SHARMA, Basingstoke (GB); Lars NORD, Lund (SE)

(73) Assignee: Sony Group Corporation, Tokyo (JP)

(21) Appl. No.: 17/311,375

(22) PCT Filed: Nov. 28, 2019
(86) PCT No.: PCT/EP2019/082941

§ 371 Date: Jun. 7, 2021

(51) Int. Cl. H04W 36/00; H04W 36/08; H04W 12/08; H04W 12/106; H04W 12/033

(52) U.S. Cl. CPC H04W 36/0038; H04W 36/08; H04W 12/033; H04W 12/106; H04W 12/08

(57) ABSTRACT

A method of communicating by a communications device in a wireless communications network, the wireless communications network comprising a core network, an infrastructure equipment providing a wireless access interface in a cell for transmitting and receiving data to and from the communications device, the method comprising controlling the communicating by the communications device in the wireless communications network, determining whether one or more predetermined conditions associated with a security function are met, wherein determining whether the one or more predetermined conditions are met comprises determining whether the security function is to be enabled for communications with the communications device in the cell, and if the one or more predetermined conditions are met, transmitting a security status indication to the core network, the security status indication indicating whether the security function is to be enabled for communications with the communications device in the cell.

### BACKGROUND

### Field

The present disclosure relates to communications devices, infrastructure equipment, core network equipment and methods for the transmission of data by a communications device in a wireless communications network.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Third and fourth generation mobile telecommunication systems, such as those based on the 3GPP defined UMTS and Long Term Evolution (LTE) architecture, are able to support more sophisticated services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, may be expected to increase ever more rapidly.

Future wireless communications networks will be expected to support communications routinely and efficiently with a wider range of devices associated with a wider range of data traffic profiles and types than current systems are optimised to support. For example it is expected future wireless communications networks will be expected to efficiently support communications with devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance.

In view of this there is expected to be a desire for future wireless communications networks, for example those which may be referred to as 5G or new radio (NR) system/new radio access technology (RAT) systems [1], as well as future iterations/releases of existing systems, to efficiently support connectivity for a wide range of devices associated with different applications and different characteristic data traffic profiles.

The increasing use of different types of communications devices having different capabilities gives rise to new challenges for efficiently handling communications in wireless telecommunications systems that need to be addressed.

### SUMMARY

The present disclosure can help address or mitigate at least some of the issues discussed above.

Embodiments of the present technique can provide a method of communicating by a communications device in a wireless communications network, the wireless communications network comprising a core network, an infrastructure equipment providing a wireless access interface in a cell for transmitting and receiving data to and from the communications device, the method comprising controlling the communicating by the communications device in the wireless communications network, determining whether one or more predetermined conditions associated with a security function are met, wherein determining whether the one or more predetermined conditions are met comprises determining whether the security function is to be enabled for communications with the communications device in the cell, and if the one or more predetermined conditions are met, transmitting a security status indication to the core network, the security status indication indicating whether the security function is to be enabled for communications with the communications device in the cell.

Embodiments of the present technique, which further relate to infrastructure equipment, core network equipment, methods of operating communications devices, methods of operating infrastructure equipment and methods of operating core network equipment and circuitry for communications devices, infrastructure equipment and core network equipment, can provide arrangements which allow for effective detection and response to a disabling of a security function.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and:

FIG. 1 schematically represents some aspects of a LTE-type wireless telecommunication system which may be configured to operate in accordance with example embodiments of the present disclosure;

FIG. 2 schematically represents some example aspects of a new radio access technology (RAT) wireless communications network which may be configured to operate in accordance with embodiments of the present disclosure;

FIG. 3 illustrates a conventional handover process;

FIG. 4 schematically shows a telecommunications system according to an embodiment of the present disclosure;

FIG. 5 is a message sequence chart illustrating techniques in accordance with embodiments of the present technique;

FIG. 6 illustrates an example of a security function disabled indication, in accordance with embodiments of the present technique; and

FIG. 7 is a further message sequence chart illustrating techniques in accordance with embodiments of the present technique.

### DETAILED DESCRIPTION OF THE EMBODIMENTS

Long Term Evolution Advanced Radio Access Technology (4G)

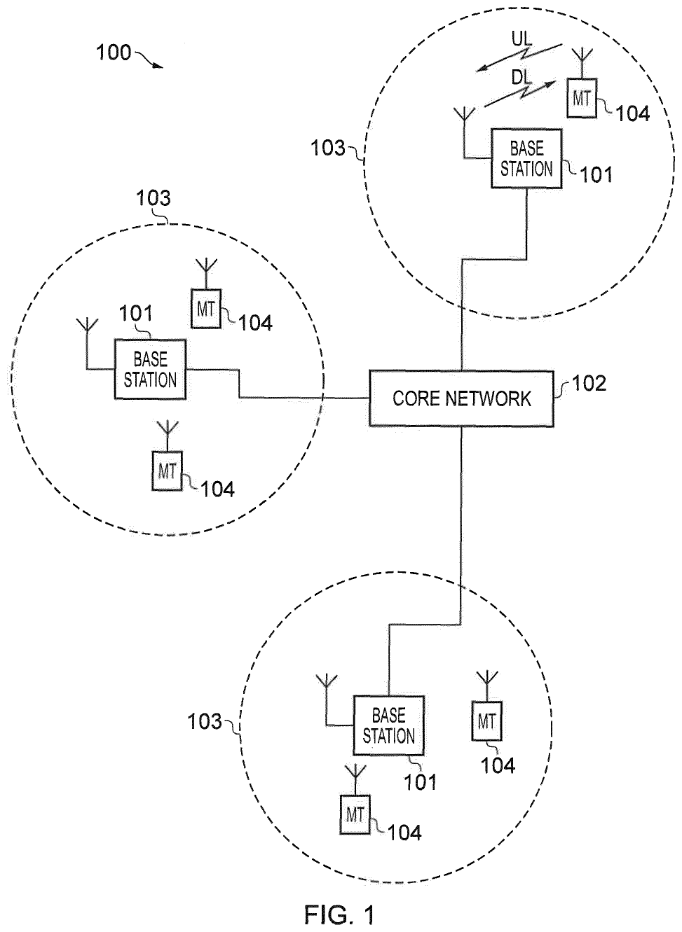

FIG. 1 provides a schematic diagram illustrating some basic functionality of a mobile telecommunications network/system 100 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP® body, and also described in many books on the subject, for example, Holma H. and Toskala A [2]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 100 includes a plurality of base stations 101 connected to a core network part 102. Each base station provides a coverage area 103 (e.g. a cell) within which data can be communicated to and from communications devices 104, and within which a communications device may obtain service. Data is transmitted from the base stations 101 to the communications devices 104 within their respective coverage areas 103 via a radio downlink. Data is transmitted from the communications devices 104 to the base stations 101 via a radio uplink. The core network part 102 routes data to and from the communications devices 104 via the respective base stations 101 and provides functions such as authentication, mobility management, charging and so on. Communications devices may also be referred to as mobile stations, user equipment (UE), user terminals, mobile radios, terminal devices, and so forth.

Communications devices 104 may operate in accordance with specifications relating to cellular IoT (CIOT). For example, the communications device 104 may operate in accordance with narrowband IoT (NB-IoT), ‘cat-NBx’ or ‘cat Mx’ (where ‘x’ may represent an integer) requirements,

Accordingly the core network 102 may comprise an core network having suitable optimizations. For example, the core network 102 may comprise an enhanced packet core (EPC) that is enhanced with support for Control Plane CIoT optimizations or User Plane CIoT optimizations. Alternatively, the core network 102 may comprise a 5G Core (5GC) network supporting CIoT optimizations in the 5GC.

Base stations, which are an example of network infrastructure equipment/network access nodes, may also be referred to as transceiver stations/nodeBs/e-nodeBs, g-nodeBs and so forth. In this regard different terminology is often associated with different generations of wireless telecommunications systems for elements providing broadly comparable functionality. However, example embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

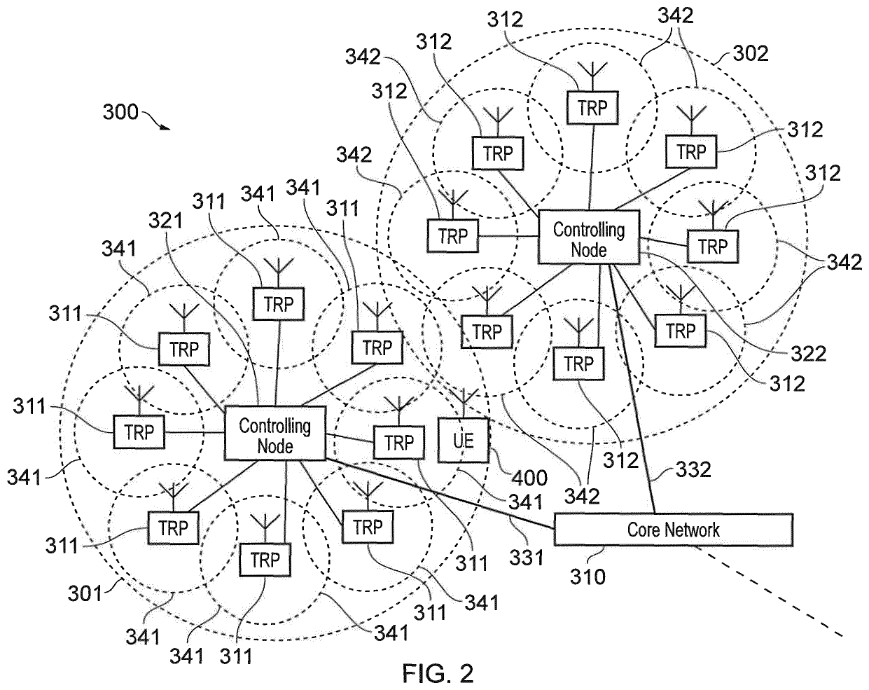

FIG. 2 is a schematic diagram illustrating a network architecture for a new RAT wireless communications network/system 300 based on previously proposed approaches which may also be adapted to provide functionality in accordance with embodiments of the disclosure described herein. The new RAT network 300 represented in FIG. 2 comprises a first communication cell 301 and a second communication cell 302. Each communication cell 301, 302, comprises a controlling node (centralised unit) 321, 322 in communication with a core network component 310 over a respective wired or wireless link 331, 332. The respective controlling nodes 321, 322 are also each in communication with a plurality of distributed units (radio access nodes/remote transmission and reception points (TRPs)) 311, 312 in their respective cells. Again, these communications may be over respective wired or wireless links. The distributed units 311, 312 are responsible for providing the radio access interface for communications devices connected to the network. Each distributed unit 311, 312 has a coverage area (radio access footprint) 341, 342 which together define the coverage of the respective communication cells 301, 302. Each distributed unit 311, 312 includes transceiver circuitry for transmission and reception of wireless signals and processor circuitry configured to control the respective distributed units 311, 312.

In terms of broad top-level functionality, the core network component 310 of the new RAT communications network represented in FIG. 2 may be broadly considered to correspond with the core network 102 represented in FIG. 1, and the respective controlling nodes 321, 322 and their associated distributed units/TRPs 311, 312 may be broadly considered to provide functionality corresponding to the base stations 101 of FIG. 1. The term network infrastructure equipment/access node may be used to encompass these elements and more conventional base station type elements of wireless communications systems. Depending on the application at hand the responsibility for scheduling transmissions which are scheduled on the radio interface between the respective distributed units and the communications devices may lie with the controlling node/centralised unit and/or the distributed units/TRPs.

A communications device 400 is represented in FIG. 2 within the coverage area of the first communication cell 301. This communications device 400 may thus exchange signalling with the first controlling node 321 in the first communication cell via one of the distributed units 311 associated with the first communication cell 301. In some cases communications for a given communications device are routed through only one of the distributed units, but it will be appreciated in some other implementations communications associated with a given communications device may be routed through more than one distributed unit, for example in a data duplication scenario and other scenarios.

The particular distributed unit(s) through which a communications device is currently connected through to the associated controlling node may be referred to as active distributed units for the communications device. Thus the active subset of distributed units for a communications device may comprise one or more than one distributed unit (TRP). The controlling node 321 is responsible for determining which of the distributed units 311 spanning the first communication cell 301 is responsible for radio communications with the communications device 400 at any given time (i.e. which of the distributed units are currently active distributed units for the communications device). Typically this will be based on measurements of radio channel conditions between the communications device 400 and respective ones of the distributed units 311. In this regard, it will be appreciated that the subset of the distributed units in a cell which are currently active for a communications device will depend, at least in part, on the location of the communications device within the cell (since this contributes significantly to the radio channel conditions that exist between the communications device and respective ones of the distributed units).

In at least some implementations the involvement of the distributed units in routing communications from the communications device to a controlling node (controlling unit) is transparent to the communications device 400. That is to say, in some cases the communications device may not be aware of which distributed unit is responsible for routing communications between the communications device 400 and the controlling node 321 of the communication cell 301 in which the communications device is currently operating, or even if any distributed units 311 are connected to the controlling node 321 and involved in the routing of communications at all. In such cases, as far as the communications device is concerned, it simply transmits uplink data to the controlling node 321 and receives downlink data from the controlling node 321 and the communications device has no awareness of the involvement of the distributed units 311, though may be aware of radio configurations transmitted by distributed units 311. However, in other embodiments, a communications device may be aware of which distributed unit(s) are involved in its communications. Switching and scheduling of the one or more distributed units may be done at the network controlling node based on measurements by the distributed units of the communications device uplink signal or measurements taken by the communications device and reported to the controlling node via one or more distributed units.

In the example of FIG. 2, two communication cells 301, 302 and one communications device 400 are shown for simplicity, but it will of course be appreciated that in practice the system may comprise a larger number of communication cells (each supported by a respective controlling node and plurality of distributed units) serving a larger number of communications devices.

It will further be appreciated that FIG. 2 represents merely one example of a proposed architecture for a new RAT communications system in which approaches in accordance with the principles described herein may be adopted, and the functionality disclosed herein may also be applied in respect of wireless communications systems having different architectures.

Thus example embodiments of the disclosure as discussed herein may be implemented in wireless telecommunication systems/networks according to various different architectures, such as the example architectures shown in FIGS. 1 and 2. It will thus be appreciated the specific wireless communications architecture in any given implementation is not of primary significance to the principles described herein.

In this regard, example embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 101 as shown in FIG. 1 which is adapted to provide functionality in accordance with the principles described herein, and in other examples the network infrastructure equipment/access node may comprise a control unit/controlling node 321, 322 and/or a TRP 311, 312 of the kind shown in FIG. 2 which is adapted to provide functionality in accordance with the principles described herein.

The embodiments of the present invention can find application with advanced wireless communications systems such as those referred to as 5G or New Radio (NR) Access Technology. Systems incorporating NR technology are expected to support different services (or types of services), which may be characterised by different requirements for latency, data rate and/or reliability. For example, Enhanced Mobile Broadband (eMBB) services are characterised by high capacity with a requirement to support up to 20 Gb/s. The requirements for Ultra Reliable & Low Latency Communications (URLLC) [1] services are for a reliability of 1-10⁵ (99.999%) for one transmission of a 32 byte packet with a user plane latency of 1 ms [3]. Massive Machine Type Communications (mMTC) is another example of a service which may be supported by NR-based communications networks.

The elements of the wireless access network shown in FIG. 1 may be equally applied to a 5G new RAT configuration, except that a change in terminology may be applied as mentioned above.

Access Stratum Security

Within the wireless communications network, one or more security functions may be in operation to protect the confidentiality and/or the integrity of data transmitted to or from the communications device 104, via the infrastructure equipment 101. Different security functions may be in operation in respect of different types of data, depending on, for example, network operator policies. For example, in a particular scenario, radio resource control (RRC) signalling may be subject to both confidentiality (e.g. encryption) and integrity protection functions, while user plane data (such as data originating at an application layer) may be subject to only confidentiality protection and integrity protection of user plane data may be disabled. According to conventional techniques, RRC signalling which may be transmitted via a signalling radio bearer (SRB) may be required to always be subject to confidentiality and integrity protection.

The integrity protection function may comprise the addition of a message authentication code (MAC) to a message, by which a recipient can confirm the identity of the sender of the message.

The confidentiality protection function may comprise the encryption of data, such that only an intended recipient can decrypt the encrypted data to obtain the original unencrypted data.

In operation, the security functions may depend on one or more parameters. Collectively, parameters which are used by security functions within an access stratum portion of the wireless communications network (such as at the infrastructure equipment 101) may form all or part of a security context, for example a 5G access stratum (AS) security context for 3GPP access (see [4]).

The parameters used for security functions within the access stratum may be determined by the core network 102, in accordance with stored parameters (such as one or more keys) associated with the communications device 104 or a subscription associated with the communications device 104.

Mobility

Within a wireless communication system, a current serving cell of a communications device (such as the communications device 104 of FIG. 1, or the communications device 400 of FIG. 2) may become less suitable than an alternative cell. This may be because the communications device 104 has moved, because of congestion within the serving cell, because of an inability of an infrastructure equipment associated with the serving cell to support a traffic load and/or quality of service requirement associated with the communications device, or for any other reason.

In such a scenario, the ‘source’ infrastructure equipment associated with the serving cell may initiate a handover of the communications device, so that it can select as its serving cell a different cell, which may be associated with a different ‘target’ infrastructure equipment.

Where the source infrastructure equipment and target infrastructure equipment are communicatively connected, by means of an interface that (at least logically) does not traverse the core network 102 such as an X2 or Xn type interface, aspect of the handover process may be facilitated by means of messages transmitted and received via this interface. This may reduce a latency associated with a handover, and may reduce a processing load for the core network 102.

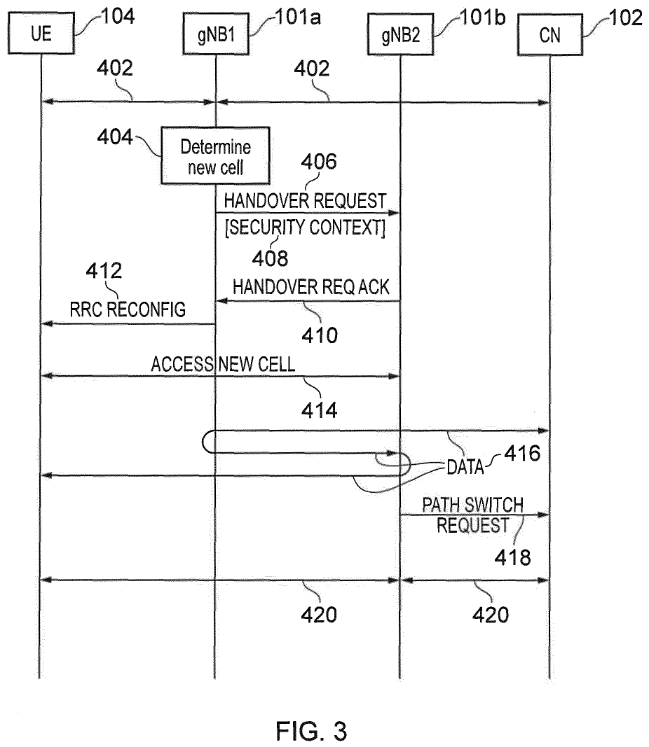

Aspects of a conventional handover process are illustrated in FIG. 3.

Initially, the communications device 104 is being served in a first cell 103a associated with a source infrastructure equipment 101a which may be a first infrastructure equipment. Data 402 is transmitted to or from the core network 102 from or to the communications device 104, via the source infrastructure equipment 101a. Access stratum security functions may be in operation at the communications device 104 and the source infrastructure equipment 101a to ensure confidentiality and/or integrity of data transmitted between the source infrastructure equipment 101a and the communications device 104. As such, the source infrastructure equipment 101a may have stored a security context associated with the communications device 104, which provides parameters (such as keys, etc.) for use in implementing the security functions.

In response to a determination 404 by the source infrastructure equipment 101a that the communications device 104 should, in future, be served in a different cell, the source infrastructure equipment 101a may initiate a handover procedure with the target infrastructure equipment 101b. In the example of FIG. 3, the source infrastructure equipment 101a and the target infrastructure equipment 101b are connected by an X2 or Xn (inter-infrastructure equipment) connection.

The handover preparation may thus occur without specific interaction with the core network 102. As part of the handover preparation, the source infrastructure equipment 101a transmits a handover request 406 to the target infrastructure equipment 101b to allocate communications resources in the new cell for the communications device 104. The handover request 406 may include a security context which has been used in the source cell by the source infrastructure equipment 101a. In response, the target infrastructure equipment 101b transmits to the source infrastructure equipment 101a a handover request acknowledge message 410, containing parameters for the use of the communications device 104 in the new cell. The parameters may include a new security context to be used in the target cell. The parameters are forwarded to the communications device 104, in an RRC reconfiguration message 412.

The RRC reconfiguration message 412 may indicate which security function(s), if any, are to be applied in respect of which data transmissions in the new cell. The indication may be explicit, or may be implicit (e.g. based on the presence or absence of corresponding security parameters in the new security context). In some scenarios, the SRB security status (that is, which security function(s) is/are to be applied to data transmitted via the SRB) is kept unchanged.

In response to receiving the RRC reconfiguration message 412, the communications device 104 accesses the new cell, for example using a random access procedure 414.

At this stage, entities in the core network 102 are not aware that the serving cell of the communications device 104 has changed, and data 416 received from the core network 102 for onward transmission to the communications device 104 by the source infrastructure is forwarded to the target infrastructure equipment 101b.

Thus, in order to notify the core network 102 of the change of serving cell (and, more particularly, of serving infrastructure equipment), the target infrastructure equipment 101b sends a Path Switch Request message 418 to the core network 102, in response to which, the core network 102 subsequently transmits data 420 for the communications device 104 to the target infrastructure equipment 101b instead of the source infrastructure equipment 101a.

In order for the target infrastructure equipment 101b to perform the same security functions in respect of data transmitted to or by the communications device 104 as the source infrastructure equipment 101a, the source infrastructure equipment 101a may transfer the security context 408 via the X2 or Xn interface, for example as part of the handover request 406.

In order to provide greater flexibility of the wireless communications network, particular in respect of constrained devices with very limited processing capabilities, it has been suggested that conventional restrictions on the application of security functions applied at the access stratum level to data transmitted to or by communications devices may be relaxed.

For example, it may be permitted that for certain types of communications devices, or for communications devices supporting certain applications, security functions which conventionally might be required to be enabled may be no longer mandatory, or may be no longer mandatory in certain circumstances.

Such modifications to the conventional principles may reflect the provision of certain security functions at a higher protocol layer, such as at the application layer, and/or a desire to avoid unnecessary processing associated with security functions in communications devices which have limited processing capability and/or have stringent power consumption requirements.

In general, then, a security function may be considered as optional, in the sense that it may be permitted, according to standards specifications, for that security function to be not enabled (in other words, disabled). Restrictions on when an optional security function may be disabled may be set by one or more of standards specifications, user preferences, application requirements, core network policy and wireless network operator policy and configuration.

Thus, a reduction in security functions may be in principle permitted for at least some communications devices, even if not in fact applied in respect of a particular communications device.

Similarly, conventional restrictions on which security function(s) may be applied to data may be relaxed or adapted to permit improved access stratum security. For example, from 3GPP Release 15, data associated with a data radio bearer (DRB) in an NR radio access network may be optionally subject to both integrity protection and confidentiality protection.

While these modifications provide greater flexibility and may accommodate a greater range of device types, applications and their respective requirements and constraints, it is nevertheless necessary to ensure that the operation of a wireless communications network is not degraded as a result of the presence of infrastructure equipment which (whether as a result of malicious activity, fault, or for any other reason) does not comply with appropriate security requirements, such as those specified in relevant standards specifications.

According to embodiments of the present disclosure, there is provided a method of communicating by a communications device in a wireless communications network, the wireless communications network comprising a core network, an infrastructure equipment providing a wireless access interface in a cell for transmitting and receiving data to and from the communications device, the method comprising controlling the communicating by the communications device in the wireless communications network, determining whether one or more predetermined conditions associated with a security function are met, wherein determining whether the one or more predetermined conditions are met comprises determining whether the security function is to be enabled for communications with the communications device in the cell, and if the one or more predetermined conditions are met, transmitting a security status indication to the core network, the security status indication indicating whether the security function is to be enabled for communications with the communications device in the cell.

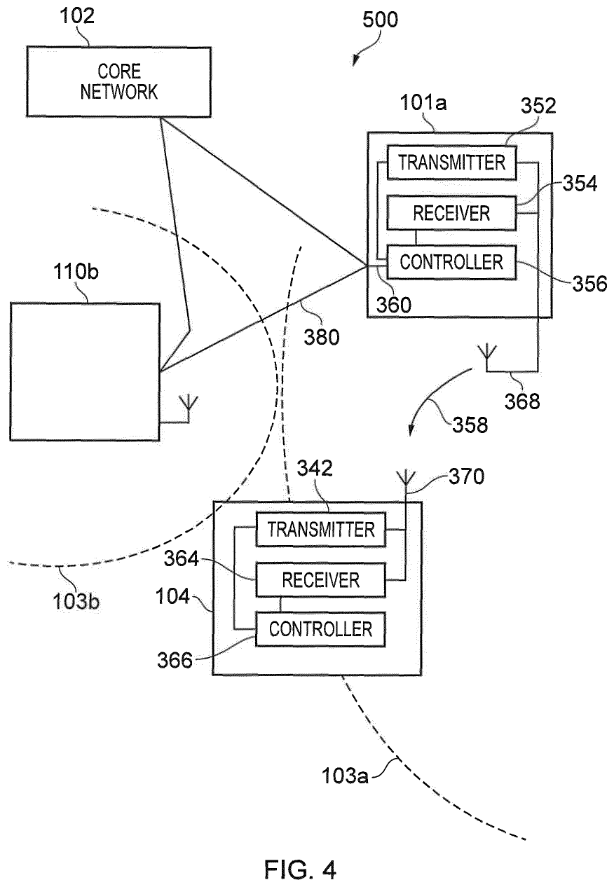

FIG. 4 schematically shows a telecommunications system 500 according to an embodiment of the present disclosure.

The telecommunications system 500 comprises a core network part 102 coupled to a radio network part. The radio network part comprises source infrastructure equipment 101a and target infrastructure equipment 101b, each of which may be examples of infrastructure equipment such as an evolved-nodeB (eNB) providing an LTE wireless access interface, a next generation eNB (ng-eNB) for connection to a 5G core network, or a gNB 101 (providing an NR wireless access interface). The source infrastructure equipment 101a may be coupled, via a wireless access interface illustrated generally by arrow 358, to a communications device 104 (which may also be referred to as a terminal device). The wireless access interface 358 may be broadly compliant with LTE- or NR-based standards. It will of course be appreciated that in practice the radio network part may comprise a plurality of infrastructure equipment serving a larger number of communications devices across various communication cells. However, only two infrastructure equipment and a single communications device are shown in FIG. 4 in the interests of simplicity.

The radio network part may be, for example, an Evolved Universal Terrestrial Radio Access Network (E-UTRAN) or a NR radio access network, and the core network may be a 5G core network or an enhanced packet core (EPC).

As such many aspects of the operation of the telecommunications system/network 500 are known and understood and are not described here in detail in the interest of brevity. Operational aspects of the telecommunications system 500 which are not specifically described herein may be implemented in accordance with any known techniques, for example according to the current NR-standards.

As noted above, the operation of the various elements of the communications system 500 shown in FIG. 4 may be broadly conventional apart from where modified to provide functionality in accordance with embodiments of the present disclosure as discussed herein.

The source infrastructure equipment 101a provides service in the first cell 103a which may be a source cell. The source infrastructure equipment 101a is connected to the core network 102 via an interface 360 to a controller 356. The source infrastructure equipment 101a includes a receiver 354 connected to an antenna 368 and a transmitter 352 connected to the antenna 368. The receiver 354 and the transmitter 352 are both connected to the controller 356. The controller 356 is configured to control the infrastructure equipment infrastructure equipment 101a and may comprise processor circuitry which may in turn comprise various sub-units/sub-circuits for providing functionality as explained further herein. These sub-units may be implemented as discrete hardware elements or as appropriately configured functions of the processor circuitry. Thus the controller 356 may comprise circuitry which is suitably configured/programmed to provide the desired functionality using conventional programming/configuration techniques for equipment in wireless telecommunications systems. The transmitter 352, receiver 354 and controller 356 are schematically shown in FIG. 4 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the source infrastructure equipment 101a will in general comprise various other elements associated with its operating functionality.

Correspondingly, the communications device 104 includes a controller 366 connected to a receiver 364 which receives signals from an antenna 370. The controller 366 is also connected to a transmitter 362 which is also connected to the antenna 370. The controller 366 is configured to control the communications device 104 and may comprise processor circuitry which may in turn comprise various sub-units/sub-circuits for providing functionality as explained further herein. These sub-units may be implemented as discrete hardware elements or as appropriately configured functions of the processor circuitry. Thus the controller 516 may comprise circuitry which is suitably configured/programmed to provide the desired functionality using conventional programming/configuration techniques for equipment in wireless telecommunications systems. The transmitter 512, receiver 514 and controller 516 are schematically shown in FIG. 4 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the communications device 104 will in general comprise various other elements associated with its operating functionality, for example a power source, user interface, and so forth, but these are not shown in FIG. 4 in the interests of simplicity.

A target infrastructure equipment 101b, providing service in a second cell 103b may be connected via an inter-infrastructure equipment interface 380 (such as an X2 or Xn interface) to the source infrastructure equipment 101a.

The target infrastructure equipment 101b may be substantially similar to the source infrastructure equipment 101a; details have been omitted from FIG. 4 for conciseness.

However, one or both of source infrastructure equipment 101a and target infrastructure equipment 101b may not operate in compliance with appropriate security requirements, such as those specified in relevant standards specification and/or may operate such that the effective operation of the communications device 104, the wireless communications network, or both is compromised.

For example, the source infrastructure equipment 101a may attempt to cause the communications device 104 to disable a security function. This may be in violation of policies of the wireless communications network, principles of a specification with which the wireless communications network is intended to be compliant, or undesirable for any other reason.

Alternatively, the source infrastructure equipment 101a may attempt to cause the communications device 104 to enable a security function which is not appropriate. Enabling the security function may not be appropriate because the function may not be supported by the communications device 104, requires unnecessary processing resulting in increased power consumption, or may duplicate the functionality of another security function, such as one provided at a different protocol layer, such as by an application. Such enabling may be in violation of policies of the wireless communications network, principles of a specification with which the wireless communications network is intended to be compliant, or undesirable for any other reason.

There may be legitimate reasons for enabling or disabling a particular optional security function which is currently (or previously has been) disabled or enabled, respectively. It may not be possible for the communications device 104 or infrastructure equipment 101a, 101b to determine whether such a change is permitted, for example because it depends on policies which are only known by one or more elements within the core network 102.

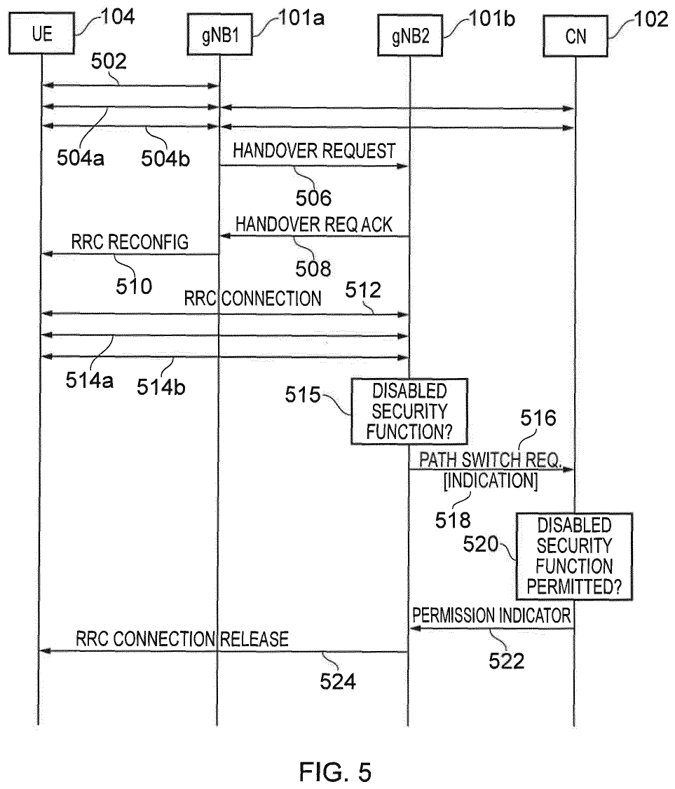

FIG. 5 is a message sequence chart illustrating techniques for detecting and/or preventing a change in the status (enabled/disabled) of a security function, where that change of status is in fact not permitted.

Initially, an RRC connection 502 and associated signalling radio bearer (not shown) is established between the communications device 104 in the first cell 103a and the source infrastructure equipment 101a. One or more radio bearers 504a, 504b may be established between the communications device 104 and the source infrastructure equipment 101a, and corresponding bearers 506a, 506b may be established between the source infrastructure equipment 101a and the core network 102.

The RRC connection 502 and the radio bearers 504a, 504b may have been first established in the first cell 103a controlled by the source infrastructure equipment 101a, or may have been established in another cell and been the subject of a handover to the first cell 103a.

One or more access stratum security functions are activated in respect of some or all of the transmissions between the communications device 104 and the source infrastructure equipment 101a. As such, the source infrastructure equipment 101a has a security context associated with the communications device 104, providing parameters associated with the one or more access stratum security functions. The security context may have been obtained from another infrastructure equipment or from the core network 102. In some embodiments, the core network 102 may have stored a security context which comprises an indication of which access stratum security functions are active for the transmissions between the source infrastructure equipment 101a and the communications device 104.

The source infrastructure equipment 101a subsequently transmits a handover request 506 to the target infrastructure equipment 101b via an Xn interface to initiate a handover of the communications device 104 from the first cell 103a to a second cell 103b controlled by the target infrastructure equipment 101b. As such, the second cell 103b may be a target cell.

The determination to initiate a handover may be in accordance with conventional, well-known techniques.

Conventionally, in most common scenarios, the same access stratum security functions would be expected to be applied in respect of communications between the communications device 104 and the target infrastructure equipment 101b in the second cell 103b, as were applied between the communications device 104 and the source infrastructure equipment 101a in the first cell 103a. As described above, in respect of FIG. 3, in order to facilitate this, an indication of which security functions to apply, and (where applicable) the corresponding parameters are therefore be transmitted from the source infrastructure equipment 101a to the target infrastructure equipment 101b.

In the example of FIG. 5, in accordance with embodiments of the present technique, the target infrastructure equipment 101b determines whether the status of one or more optional security functions, as indicated by the source infrastructure equipment 101a, satisfies predetermined conditions for triggering further action.

The predetermined conditions may be those specified in a relevant standard, indicated to the target infrastructure equipment 101b by the core network 102, configured in the target infrastructure equipment 101b by an operator of the wireless communications network, or set in any other way.

In the example of FIG. 5, the conditions are satisfied if an optional security feature is disabled.

Therefore, the target infrastructure equipment 101b determines whether the status of one or more optional security functions, as indicated by the source infrastructure equipment 101a, satisfies the conditions by making a disabled security function determination 515, based on signalling (or the absence thereof) from the source infrastructure equipment 101a. As part of the disabled security function determination 515, the target infrastructure equipment 101b determines whether one or more optional access stratum security functions is not to be enabled in the second cell 103b.

The target infrastructure equipment 101b may evaluate the conditions (for example, in making the disabled security function determination 515) based on one or more of the following:
an explicit indication of which optional security functions are to be activated in the target cell 103b, indicating that one or more optional security functions are, or are not to be enabled in the second cell 103b;
implicit indication based on an absence of security parameters (for example, in a security context) associated with a security function to be disabled, or an absence of a security context.

The determination as to whether the conditions are met (such as the disabled security function determination 515) may be made in response to receiving the handover request 506, or may be made subsequently.

More specifically, the determination as to whether the conditions are met may comprise a disabled security function determination 515 that a security function which may be optionally enabled in respect of a communications device, or in respect of a particular bearer or type of data, is not to be enabled in respect of the communications device 104 or a bearer or type of data for the communications device 104.

In some embodiments, the conditions may additionally or alternatively be met for a security function which may be optionally enabled in respect of a communications device, or in respect of a particular bearer or type of data, which is not to enabled in respect of the communications device 104 or a bearer or type of data for the communications device 104.

In some embodiments, the conditions are evaluated for each optional security function and/or for each type of data (for example, for data associated with each SRB and each DRB). In some scenarios, for some data types (e.g. data associated with an SRB) there may be no optional security functions, in which case the conditions may not be evaluated in respect of that data. However, in such scenarios, the conditions may be satisfied in respect of security functions which are optional for data associated with one or more DRBs.

In some embodiments, conditions may differ for different communications devices 104. For example, the conditions may differ because the set of optional security functions for a given type of data is different for different devices. In some embodiments, a first set of conditions is used for communications devices supporting one or more cellular IoT capabilities, and a second, different set of conditions is used for communications devices not supporting any IoT capabilities.

In some embodiments, the second set of conditions do not apply to data associated with an SRB. In some embodiments, the first set of conditions apply to data associated with an SRB.

In some embodiments, different conditions apply to security functions which provide confidentiality from those applicable to security functions which provide integrity protection.

The target infrastructure equipment 101b may not be able to determine which optional security function(s) was/were applied in the first cell 103a. In other words, the target infrastructure equipment 101b may be unable to determine whether the security function(s) which it is requested to enable for the communications device 104 in the second cell 103b are the same as, or are different from, those enabled by the source infrastructure equipment 101a in the first cell 103a.

The target infrastructure equipment 101b then proceeds as for a conventional inbound handover procedure by allocating resources for the communications device 104 and transmitting an indication of these resources to the source infrastructure equipment 101a, for example in a handover request acknowledge message 508. Security functions may be enabled in accordance with the indication received from the source infrastructure equipment 101a, such as the handover request 506.

Some or all of the contents of the handover request acknowledge message 508 may be forwarded to the communications device 104, for example, in a RRC Reconfiguration message 510.

In response to receiving the RRC Reconfiguration message 510, the communications device 104 establishes a new RRC connection 512 between the communications device 104 and the target infrastructure equipment 101b.

Radio bearers 504a, 504b may also be handed over and established in the new cell 103b as new radio bearers 514a, 514b.

In addition, if the conditions used at step 515 are satisfied, then the target infrastructure equipment 101b initiates further action. In some embodiments, the further action comprises transmitting, by the target infrastructure equipment 101b, an indication of the security status of one or more optional security functions to the core network 102.

Thus, in the specific example of FIG. 5, in response to the outcome of the disabled security function determination 515 being that at least one optional security function is not to be enabled for the communications device 104 in the second cell 103b, in accordance with embodiments of the present technique, the target infrastructure equipment 101b transmits a security status indication 518 to the core network 102.

In some embodiments, the action triggered by the determination that the conditions are met may occur prior to the establishment of any connection with the communications device 104 in the second cell 103b, for example, substantially immediately in response to the determination being made.

In some embodiments, as illustrated in FIG. 5, the action triggered by the determination that the conditions are met may occur after the establishment of a connection with the communications device 104 in the second cell 103b. In particular, in some embodiments, the security status indication 518 may form a part of a path switch request 516 which requests the core network 102 to associate the target infrastructure equipment 101b with the communications device 104 and to transmit data for the communications device 104 to the target infrastructure equipment 101b. The path switch request 516 may comprise an indication of security capabilities of the communications device 104. The security status indication 518 may indicate which security function(s) is/are disabled and enabled in respect of the communications device 104 in the second cell 103b. In some embodiments, the security status indication 518 further indicates for which data the security function(s) is/are disabled or enabled. For example, in some embodiments, a separate instance of the security status indication 518 may be transmitted for each of one or more protocol data unit (PDU) sessions. An instance of the security status indication 518 may thus indicate that, for example, encryption is not enabled in respect of data associated with a particular protocol data unit (PDU) session.

In some embodiments, the security status indication 518 indicates which security function(s) is/are enabled (or, if the security status indication 518 is transmitted prior to a connection being established in the new cell, is or are to be enabled) in respect of the communications device 104 in the second cell 103b.

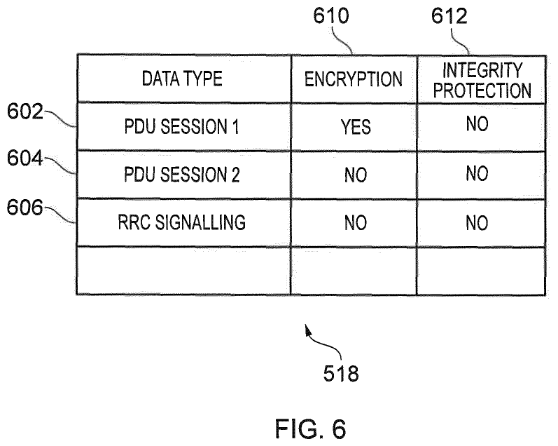

An example of the information that may be indicated by the security status indication 518 illustrated in FIG. 5, in accordance with embodiments of the present technique, is illustrated in FIG. 6.

In the example shown in FIG. 6, information relating to each of a first PDU session 602 and a second PDU session 604 (which may correspond to data transmitted by the first and second bearers 504a, 504b respectively of FIG. 5) and to RRC signalling (such as that which may be sent via signalling radio bearer 502 of FIG. 5). For each, the security status indication 518 may comprise a confidentiality indication 610, indicating whether or not a confidentiality security function (e.g. by means of encryption) is to be applied, and an integrity protection indication 612 indicating whether or not an integrity protection security function is to be applied.

In response to receiving the security status indication 518, the core network 102 makes a security status permitted determination 520. In the example of FIG. 5, the security status permitted determination 520 is a disabled security function permitted determination by which the core network 102 determines whether the security function(s) which are optional and which are indicated, by the security status indication 518 as being disabled, are permitted to be disabled.

The security status permitted determination 520 may be based on one or more of:
policy associated with an application associated with a bearer; such policy may itself be based on which, if any, security functions are provided by the application itself;
policy associated with the communications device 104;
policy associated with a subscription used by the communications device 104;
a capability of the communications device 104;
the security context for the communications device 104 stored in the core network 102;
security functions provided at other protocol layers;
a security status associated with the infrastructure equipment, such as the target infrastructure equipment 101b, and
whether or not the indicated security function(s) were active in respect of the communications device 104 and/or the data in the first cell 103a.

In some embodiments, for example, it is determined that it is not permitted to disable a security function if that security function was active in a previous cell in respect of the same communications device and/or same type of data (e.g. same bearer), or, in some embodiments, vice versa. This may be determined, for example, based on a mismatch between the security function(s) to be enabled in the second cell 103b and the security parameters in the security context for the communications device 104 stored in the core network 102.

In some embodiments, if the data which would otherwise be subject to a disabled security function is subject to one or more similar or equivalent security functions (e.g. providing the same or better level of protection) at a different protocol layer or by an application, then it may be permitted to disable, at the access stratum, functions providing the corresponding protection. In some scenarios, for example, a bearer may be associated with an application which itself implements one or both of integrity protection and confidentiality protection. In some embodiments then, in some scenarios it is permitted to disable a security function at the access stratum if similar protection is provided by the application In some embodiments, infrastructure equipment 101 may be associated with a security status which may be indicative of a trust relationship between the core network 102 and the infrastructure equipment 101.

For example, where the infrastructure equipment 101 and the core network 102 are both operated by the same commercial entity, the security status may indicate a higher degree of security associated with the infrastructure equipment 101. Additionally or alternatively, where communications between the infrastructure equipment 101 and the core network 102 are subject to security functions and/or mutual authentication, the security status may indicate a higher degree of security associated with the infrastructure equipment 101.

In such embodiments, the core network 102 may determine that an optional access stratum security function may be disabled if the security status associated with the target infrastructure equipment 101b is above a pre-determined threshold.

Alternatively or additionally, if, for example, a communications device (such as the communications device 104) is known by the core network 102 to be limited in processing capabilities and/or power consumption (e.g. because it is required to operate using a battery for a long period of time without recharging), then it may be permitted to disable integrity protection and/or ciphering at the access stratum, either for uplink data, downlink data, or both, in order to reduce the computational and processing requirements on the communications device 104.

Similarly if a communications device is known by the core network 102 to be limited in processing capabilities and/or power consumption, then in some embodiments it may not be permitted to enable integrity protection and/or ciphering at the access stratum, either for uplink data, downlink data, or both, in order to avoid an unnecessary increase to the computational and processing requirements on the communications device 104.

The core network 102 may determine the capabilities of the communications device 104 by means of receiving a device capability indication, for example during a NAS procedure.

If, for example, a subscription associated with the communications device 104 (for example, associated with a USIM application running on a UICC or embedded UICC connected to the communications device 104) is associated with a policy which requires the use of one or both of integrity protection and confidentiality protection at the access stratum, then it may not be permitted to disable such protection at the access stratum.

Such a policy may instead, or additionally, be associated with the particular communications device 104, for example based on a part or all of a unique identifier associated with the device (such as an international mobile subscriber identity, IMSI, a temporary mobile subscriber identity, TSMI, or an international mobile equipment identity, IMEI).

In some scenarios, policies for the operation of the wireless communications network may permit a modification of security functions applied at a handover of an ongoing PDU session. For example, in a shared network scenario the communications device 104 may move from the first cell 103a in a shared network (i.e. using radio access network, RAN, sharing) having a first policy to the second cell 103b in a non-shared network having a second policy different from the first policy. As such, in some embodiments, the determination that a change in security function(s) is not permitted is based on factors other than, or additionally to, a difference in security function(s) being active in the first cell 103a and the second cell 103b.

Where the determination may be made based on multiple factors, predetermined rules may be used to apply the factors according to corresponding precedence levels, or in a particular order. For example, where the determination may be made based on a policy applicable to the communications device 104 and a policy applicable to a subscription associated with the communications device 104, the determination may be made based on the subscription in precedence to the policy associated with the communications device 104, in accordance with predetermined rules of precedence.

As a further example, in some embodiments a combination of factors may be used in the security status permitted determination 520 whereby the security status of the target infrastructure equipment 101b and the capability of the communications device 104 are jointly taken into consideration, as follows. An optional access stratum security function is permitted to be disabled with respect to data associated with a DRB only if the communications device 104 does not support a cellular IoT capability and the security status of the target infrastructure equipment 101b exceeds a predetermined threshold.

In some embodiments, the security status permitted determination 520 may be made at one of an access management function (AMF) or a session management function (SMF).

In the example shown in FIG. 5, the security status indication 518 indicates that encryption is not to be enabled in respect of data associated with the first new bearer 514a (corresponding to bearer 504a in the first cell 103a). In this example, the core network 102 has a security context associated with the communications device 104 comprising access stratum encryption parameters applicable to the first bearer 504a in the first cell 103a and thus determines that disabling encryption in respect of the first new bearer 514a in the second cell 103b is not permitted.

In response to the security status permitted determination 520, the core network 102 may indicate to the target infrastructure equipment 101b based on the outcome of the determination. In some embodiments, the indication may be an explicit permission indicator 522. The explicit permission indicator 522 may comprise a path switch request acknowledge message to indicate that the application of the security function(s) as indicated in the security status indication 518 is permitted, and may comprise a path switch request failure message to indicate that the disabling of the security function(s) is not permitted.

In some embodiments, the explicit permission indicator 522 may comprise a path switch request failure message with a cause value which indicates that the application of the security function(s) as indicated in the security status indication 518 is not permitted, such as a “security compromised” cause value. In some embodiments, if the application of the security function(s) as indicated in the security status indication 518 is not permitted, the cause value may be a conventional cause value such as “Encryption and/or integrity protection algorithms not supported” or “UP integrity protection not possible”, or “UP confidentiality protection not possible”.

In some embodiments, the indication may be implicit. For example, an absence of an explicit permission indicator 522 may indicate that the application of the security function(s) as indicated in the security status indication 518 is permitted.

As described above, the explicit permission indicator 522 may be received by the target infrastructure equipment 101b after one or more connections (such as the new radio bearers 514a, 514b and RRC connection 512) have been established in accordance with the security functions as indicated in the security status indication 518.

In such circumstances, such as are illustrated in Figure Sin response to the indication 522 by the core network 102, the target infrastructure equipment 101b may proceed with no further action if the indication 522 is that the disabling of the security function(s) is permitted.

As a result of transmitting the path switch request 516, the target infrastructure equipment 101b may receive data from the core network 102 for the communications device 104, apply security function(s), if any, in accordance with those determined above, based on indications received from the source infrastructure equipment 101a such as in the handover request 506, and transmit the data to the communications device 104. Similarly, the target infrastructure equipment 101b may receive data transmitted by the communications device 104, apply the applicable security function(s), if any, before forwarding the data directly to the core network 102.

If the indication (such as the explicit permission indicator 522) from the core network 102 indicates that the security function(s) may not be disabled in the second cell 103b (or, in general, that the application of the security function(s) as indicated in the security status indication 518 is not permitted), then in some embodiments, the target infrastructure equipment 101b may release any connections with the communications device 104 in the second cell 103b. This may be by means of transmitting to the communications device 104 an RRC connection release message 524 as shown in FIG. 5.

In some embodiments, if the core network 102 determines 520 that the application of the security function(s) as indicated in the security status indication 518 is not permitted, then no permission indicator 522 is transmitted. In some such embodiments, the core network 102 may release any connections (e.g. bearers) with the communications device 104. In some embodiments, the core network 102 may trigger an alarm, for example by transmitting an alarm message to a network operations and monitoring system associated with the wireless communications network 500.

In some embodiments, in response to determining (e.g. based on the explicit permission indicator 522) that the security function(s) may not be disabled in the second cell 103b, the target infrastructure equipment 101b initiates an authentication procedure or other suitable procedure with the communications device 104 in order to enable those security function(s) which are required by the core network 102, to be applied. The procedure may be in accordance with conventional procedures used prior to or as part of connection (or bearer) establishment.

In some such embodiments, the target infrastructure equipment 101b may transmit an RRC Security Mode command or RRC Reconfiguration message to the communications device 104 in order to enable the use of the security function(s).

In some embodiments, the target infrastructure equipment 101b may, in response to determining that the security function(s) may not be disabled in the second cell 103b, trigger an alarm, for example by transmitting an alarm message to a network operations and monitoring system. The alarm message may trigger a human-perceptible alert, such as a visual or audible alert to alert an operator of the wireless communications network that a procedure has been attempted in which a security feature has been disabled, contrary to requirements and/or policy. The alarm message may comprise an identity of the source infrastructure equipment 101a, and/or an identity of the target infrastructure equipment 101b.

The alarm procedure may be substantially based on a conventional alarm procedure for notifying the operator that an integrity protection failure has occurred.

In some embodiments, following the security status permitted determination 520, the core network 102 may initiate a non-access stratum (NAS) procedure to establish security parameters for use by the communications device 104 and the target infrastructure equipment 101b. For example, the core network 102 may initiate a re-authentication procedure with the communications device 104, such as an authentication and key agreement (AKA) procedure. After completing the NAS procedure, the core network 102 may provide the target infrastructure equipment 101b with a security context comprising the security parameters for use by the target infrastructure equipment 101b in apply the required security function(s) in respect of data transmitted to and by the communications device 104.

In some embodiments of the present technique, a determination as to whether conditions are satisfied in respect of optional access stratum security functions may be performed by the communications device 104 and an indication broadly similar to the security status indication 518 described above may be transmitted to the core network 102 by the communications device 104 if the conditions are met. As such, for example, the disabled security function determination 515 described above may be carried out by either or both of the communications device 104 and the target infrastructure equipment 101b.

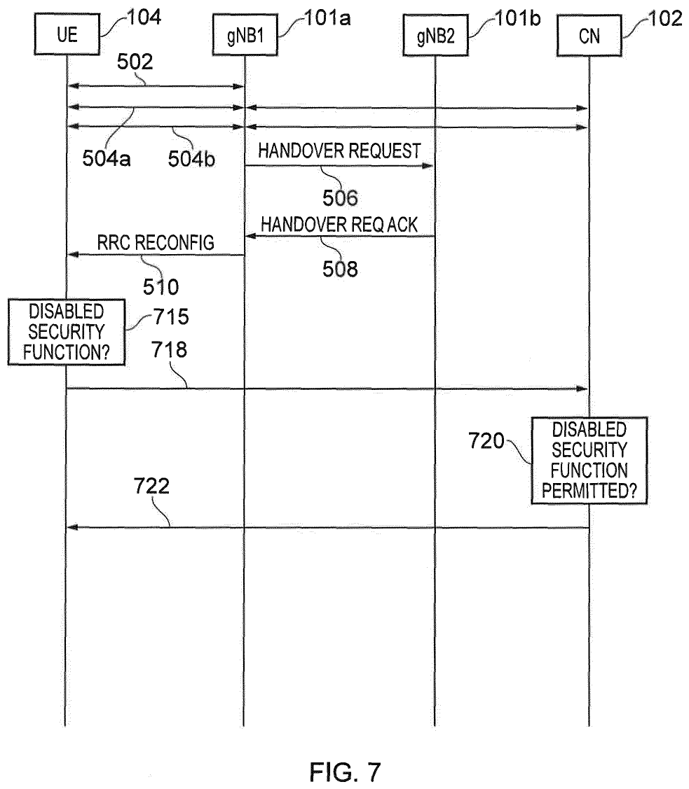

FIG. 7 is a message sequence chart illustrating a determination 715 being carried out by the communications device 104, in accordance with embodiments of the present technique.

In the example of FIG. 7, the procedure is as illustrated and described in respect of FIG. 5, up to and including the receipt of the RRC Reconfiguration message 510 by the communications device 104.

In the example of FIG. 7, the RRC Reconfiguration message 510 includes an indication of which (if any) security functions are to be enabled in respect of the communications device 104, or in respect of specific data (such as that associated with each of the bearers 504a, 504b) in the second cell 103b. The indication may be in the form of a set of parameters for use in security functions in the second cell 103b, such that security functions for which no parameters are indicated are implicitly indicated as being disabled in the second cell 103b.

In response to receiving the RRC Reconfiguration message 510 then, in the example of FIG. 7, the communications device 104 carries out a determination step 715, whereby it determines whether the status of one or more optional security functions, as indicated by the RRC Reconfiguration message 510, satisfies conditions for triggering further action. The determination step may be substantially similar to the evaluation of conditions by the target infrastructure equipment 101b, such as by means of the disabled security function determination 515 described above.

However, unlike in the example of FIG. 5, the communications device 104, in carrying out the determination step 715 is aware of which security function(s) is/are enabled in respect of each of the bearers 504a, 504b and RRC signalling 502 in the first cell 103a.

As such, in some embodiments, the determination step 715 may comprise a determination as to whether or not a security function which is enabled in the first cell 103a in respect of the communications device 104, or in respect of a particular bearer or type of data associated with the communications device 104, is not to be enabled in the second cell 103b in respect of the communications device 104 or a bearer or type of data for the communications device 104 or vice versa (i.e. a security function is to be newly enabled).

In some embodiments, the determination step 715 may comprise a determination as to whether or not a security function is not to be enabled in respect of the communications device 104 or a bearer or type of data for the communications device 104, irrespective of whether or not the security function was enabled respect of the communications device 104 or a bearer or type of data for the communications device 104 in the first cell 103a.

The determination step 715 may be based on the indication of which (if any) security functions are to be enabled in respect of the communications device 104, or in respect of specific data (such as that associated with each of the bearers 504a, 504b) in the second cell 103b, included in the RRC Reconfiguration message 510.

Following the determination 715, the communications device 104 may transmit a security status indication 718 to the core network 102 indicating an outcome of the determination 715. The security status indication 718 may be substantially similar to the security status indication 518 illustrated in FIG. 6 and described above.

In some embodiments, the conditions evaluated in the determination 715 may include those described above in respect of the evaluation of conditions by the target infrastructure equipment in the example illustrated in FIG. 5.

In some embodiments, the conditions may additionally or alternatively be satisfied if a security function which is enabled in the first cell 103a in respect of the communications device 104, or in respect of a particular bearer or type of data associated with the communications device 104, is not to be enabled in the second cell 103b in respect of the communications device 104 or a bearer or type of data for the communications device 104.

In some embodiments, the conditions may additionally or alternatively be satisfied if a security function which is not enabled in the first cell 103a in respect of the communications device 104, or in respect of a particular bearer or type of data associated with the communications device 104, is to be enabled in the second cell 103b in respect of the communications device 104 or a bearer or type of data for the communications device 104.

In some embodiments, the communications device 104 may proceed with the handover and, if the conditions evaluated in determination 715 are satisfied, send the security status indication 718 in the second cell 103b.

In some embodiments, the security status indication 718 may be transmitted in the first cell 103a, as shown in the example of FIG. 7.

In some embodiments, if the communications device 104 determines 715 that the conditions are satisfied, the communications device 104 may stop execution of the configuration received in the RRC Reconfiguration message 510, having the effect of aborting the handover and may additionally send the security status indication 718 in the first cell.

In some embodiments, the communications device 104 determines whether it is configured to perform the determination 715. For example, the communications device 104 may determine that it is configured to perform the determination 715 only if it has received an indication from the infrastructure equipment 101a (and/or, in some embodiments, from the core network 102) indicating that it is to perform the determination 715 and, depending on the outcome, to transmit the security status indication 718.

Thus, in some embodiments, before performing the determination 715, the communications device 104 may receive a configuration indication (not shown in FIG. 7) transmitted by the infrastructure equipment 101 indicating that the communications device 104 is to perform the determination 715 and, if appropriate, to transmit the security status indication 718.

In some embodiments, the communications device 104 may determine that it is configured to perform the determination 715 unless it has received a configuration indication from the infrastructure equipment 101a (and/or, in some embodiments, from the core network 102) indicating that it is not to transmit any security status indication 718.

In some embodiments, therefore, the determination 715 may be carried out by the communications device 104 depending on receiving (or not, in some embodiments) a configuration indication from either the core network 102 or the radio access network. As such, the wireless communications network is able to control which (if any) and when the communications devices 104 perform the determination 715. In some such embodiments, the wireless communications network controls the communications devices 104 so that the determination 715 is carried out only within certain time periods, and/or within certain geographical regions. For example, the wireless communications network (such as the radio access network comprising the infrastructure equipment 101a, or the core network 102) may determine that the communications device 104 is within a pre-determined geographic region, and in response, may transmit the configuration indication to the communications device 104 to indicate that it should carry out determination 715.

Similarly, the wireless communications network may determine that the communications device 104 is outside of a pre-determined geographic region, and in response, may transmit the configuration indication to the communications device 104 to indicate that it should no longer carry out the determination 715.

In some such embodiments, the determination by the wireless communications network that communications devices 104 should carry out the determination 715 is based on an assessment that a rogue (e.g., unlawful or unauthorised) base station is more likely to be in operation.

In some embodiments, the determination by the wireless communications network that communications device 104 should carry out the determination 715 may be in response to a determination that a rogue base station may be in operation in the vicinity of the communications device 104.

In some embodiments, the core network 102 may perform a determination 720 which may be substantially the same as the security status permitted determination 520 described above in respect of FIG. 5. Based on the determination 720, the core network 102 may transmit an indication 722 to the communications device 104, which may be broadly similar to the permission indicator 522 transmitted to the target infrastructure equipment 101b described in respect of FIG. 5.

Additionally or alternatively, the core network 102 may proceed as described in respect of the example of FIG. 5.

If the communications device 104 receives the indication 722 and the indication 722 indicates that the application of the security function(s) as indicated in the security status indication 718 is not permitted in the second cell 103b, the communications device 104 may abort the handover (if it has not already done so) and refrain from selecting the second cell 103b as its serving cell. In some embodiments, a handover failure message may be transmitted by the communications device 104 to the source infrastructure equipment 101a to indicate that the communications device 104 is not proceeding with the handover. The handover failure message may comprise an indication that the communications device 104 is not proceeding with the handover because of an impermissible change in security settings.

In the example of FIG. 7, the determination 715 is initiated in response to the receipt of the RRC Reconfiguration message 510 which indicates that a handover is to occur for the communications device 104.

However, in some embodiments, the process may start with the communications device 104 receiving an indication that the application of one or more access stratum security functions is to be changed in the first cell 103a. For example, this may be in response to receiving an indication that one or more access stratum security functions is to be disabled in the first cell 103a. In such embodiments, the communications device 104 may perform the determination 715 in response to determining that the application of the one or more access stratum security functions are to be changed either in the current serving cell (e.g. the first cell 103a) or in any other cell.

Thus there has been described a method of communicating by a communications device in a wireless communications network, the wireless communications network comprising a core network, an infrastructure equipment providing a wireless access interface in a cell for transmitting and receiving data to and from the communications device, the method comprising controlling the communicating by the communications device in the wireless communications network, determining whether one or more predetermined conditions associated with a security function are met, wherein determining whether the one or more predetermined conditions are met comprises determining whether the security function is to be enabled for communications with the communications device in the cell, and if the one or more predetermined conditions are met, transmitting a security status indication to the core network, the security status indication indicating whether the security function is to be enabled for communications with the communications device in the cell.

There has also been described a method of communicating with a communications device in a wireless communications network, the wireless communications network comprising a core network, an infrastructure equipment providing a wireless access interface in a cell for transmitting and receiving data to and from the communications device, the method comprising controlling the communicating by the communications device in the wireless communications network, determining by the infrastructure equipment whether one or more predetermined conditions associated with a security function are met, wherein determining whether the one or more predetermined conditions are met comprises determining whether or not the security function is to be enabled for communications with the communications device in the cell, and if the one or more predetermined conditions are met, transmitting a security status indication to the core network, the security status indication indicating whether or not the security function is to be enabled for communications with the communications device in the cell.

There has also been described a method for of controlling communications by a core network of a wireless communications network, the wireless communications network comprising the core network, an infrastructure equipment providing a wireless access interface in a cell for transmitting and receiving data to and from a communications device, the method comprising receiving a security status indication, the security status indication indicating whether a security function is to be enabled for the communications with the communications device, and security off indication, the security off indication indicating that the security function is not to be enabled for the communications with the communications device, in response to receiving the security off status indication, determining whether enabling or disabling the security function in accordance with the security status indication is required permitted to be applied to in respect of the communications with the communications device in the cell.

It will be appreciated that while the present disclosure has in some respects focused on implementations in an LTE-based and/or 5G network for the sake of providing specific examples, the same principles can be applied to other wireless telecommunications systems. Thus, even though the terminology used herein is generally the same or similar to that of the LTE and 5G standards, the teachings are not limited to the present versions of LTE and 5G and could apply equally to any appropriate arrangement not based on LTE or 5G and/or compliant with any other future version of an LTE, 5G or other standard.

It may be noted various example approaches discussed herein may rely on information which is predetermined/predefined in the sense of being known by both the base station and the communications device. It will be appreciated such predetermined/predefined information may in general be established, for example, by definition in an operating standard for the wireless telecommunication system, or in previously exchanged signalling between the base station and communications devices, for example in system information signalling, or in association with radio resource control setup signalling, or in information stored in a SIM application. That is to say, the specific manner in which the relevant predefined information is established and shared between the various elements of the wireless telecommunications system is not of primary significance to the principles of operation described herein. It may further be noted various example approaches discussed herein rely on information which is exchanged/communicated between various elements of the wireless telecommunications system and it will be appreciated such communications may in general be made in accordance with conventional techniques, for example in terms of specific signalling protocols and the type of communication channel used, unless the context demands otherwise. That is to say, the specific manner in which the relevant information is exchanged between the various elements of the wireless telecommunications system is not of primary significance to the principles of operation described herein.

It will be appreciated that the principles described herein are not applicable only to certain types of communications device, but can be applied more generally in respect of any types of communications device, for example the approaches are not limited to machine type communication devices/IoT devices or other narrowband communications devices, but can be applied more generally, for example in respect of any type communications device operating with a wireless link to the communication network.

It will further be appreciated that the principles described herein are not applicable only to LTE-based wireless telecommunications systems, but are applicable for any type of wireless telecommunications system that supports a handover from one cell to another, and the optional use of a security function in respect of communications to or from a communications device.

Further particular and preferred aspects of the present invention are set out in the accompanying independent and dependent claims. It will be appreciated that features of the dependent claims may be combined with features of the independent claims in combinations other than those explicitly set out in the claims.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology such that no inventive subject matter is dedicated to the public.

Respective features of the present disclosure are defined by the following numbered paragraphs:

Paragraph 1. A method of communicating by a communications device in a wireless communications network, the wireless communications network comprising a core network, an infrastructure equipment providing a wireless access interface in a cell for transmitting and receiving data to and from the communications device, the method comprising

controlling the communicating by the communications device in the wireless communications network, determining whether one or more predetermined conditions associated with a security function are met, wherein determining whether the one or more predetermined conditions are met comprises determining whether the security function is to be enabled for communications with the communications device in the cell, and if the one or more predetermined conditions are met, transmitting a security status indication to the core network, the security status indication indicating whether the security function is to be enabled for communications with the communications device in the cell.

Paragraph 2. A method according to paragraph 1, wherein the cell is a target cell, the method comprising receiving from a source infrastructure equipment providing a wireless access interface in a source cell a handover indication that the communications device is to change a serving cell from the source cell to the target cell, and the determining whether one or more predetermined conditions associated with a security function are met is in response to receiving the handover indication.

Paragraph 3. A method according to paragraph 2, wherein the one or more predetermined conditions comprises a condition that the security function is enabled for the communications with the communications device in the source cell.

Paragraph 4. A method according to any of paragraphs 1 to 3, wherein determining whether the security function is to be enabled for communications with the communications device in the cell comprises determining that the security function is to be disabled for the communications with the communications device in the cell, the method comprising receiving from the core network a security function permission indicator, the security function permission indicator indicating that disabling the security function for the communications with the communications device in the cell is not permitted.

Paragraph 5. A method according to paragraph 4, the method comprising in response to receiving the security function permission indicator, terminating a connection between the communications device and the infrastructure equipment.

Paragraph 6. A method according to any of paragraphs 1 to 5, wherein the one or more predetermined conditions comprises a condition that the security function is currently enabled and the security function is to be disabled for the communications with the communications device.

Paragraph 7. A method according to any of paragraphs 1 to 6, the method comprising receiving a configuration indication transmitted by the infrastructure equipment, the configuration indication indicating that the communications device is to determine whether the one or more predetermined conditions associated with the security function are met, wherein the determining whether one or more predetermined conditions associated with a security function are met is in response to receiving the configuration indication.

Paragraph 8. A method of communicating with a communications device in a wireless communications network, the wireless communications network comprising a core network, an infrastructure equipment providing a wireless access interface in a cell for transmitting and receiving data to and from the communications device, the method comprising

controlling the communicating by the communications device in the wireless communications network, determining by the infrastructure equipment whether one or more predetermined conditions associated with a security function are met, wherein determining whether the one or more predetermined conditions are met comprises determining whether or not the security function is to be enabled for communications with the communications device in the cell, and if the one or more predetermined conditions are met, transmitting a security status indication to the core network, the security status indication indicating whether or not the security function is to be enabled for communications with the communications device in the cell.

Paragraph 9. A method according to paragraph 8, wherein the cell is a target cell, the method comprising receiving a handover request from a source infrastructure equipment providing a wireless access interface in a source cell, the handover request indicating that the communications device is to change a serving cell from the source cell to the target cell, and wherein the determining whether the one or more predetermined conditions associated with the security function are met is in response to receiving the handover request indication.

Paragraph 10. A method according to paragraph 9, wherein the handover request indication comprises an indication of whether the security function is to be enabled for communications with the communications device in the target cell.

Paragraph 11. A method according to paragraph 10, the method comprising establishing a connection with the communications device in the target cell, and before transmitting to the core network the security status indication, enabling or disabling the security function in respect of the connection in accordance with the handover request indication.

Paragraph 12. A method according to any of paragraphs 8 to 11, the method comprising receiving from the core network a security function permission indicator, the security function permission indicator indicating that disabling the security function for the communications with the communications device in the cell is not permitted.

Paragraph 13. A method according to paragraph 12, the method comprising in response to receiving the security function permission indicator, enabling the security function for the communications with the communications device in the cell.

Paragraph 14. A method according to paragraph 12, the method comprising in response to receiving the security function permission indicator, terminating a connection between the communications device and the infrastructure equipment.

Paragraph 15. A communications device for use in a wireless communications network, the wireless communications network comprising an infrastructure equipment providing a wireless access interface and a core network, the communications device comprising a transmitter configured to transmit signals via the wireless access interface, a receiver configured to receive signals, and a controller configured to control the transmitter and the receiver so that the communications device is operable: to determine whether one or more predetermined conditions associated with a security function are met by determining whether the security function is to be enabled for communications with the communications device in the cell, and if the one or more predetermined conditions are met, to transmit a security status indication to the core network, the security status indication indicating whether the security function is to be enabled for communications with the communications device in the cell.

Paragraph 16. Circuitry for a communications device for use in a wireless communications network, the wireless communications network comprising an infrastructure equipment providing a wireless access interface and a core network, the circuitry comprising transmitter circuitry configured to transmit signals via the wireless access interface, receiver circuitry configured to receive signals, and controller circuitry configured to control the transmitter circuitry and the receiver circuitry so that the communications device is operable: to determine whether one or more predetermined conditions associated with a security function are met by determining whether the security function is to be enabled for communications with the communications device in the cell, and if the one or more predetermined conditions are met, to transmit a security status indication to the core network, the security status indication indicating whether the security function is to be enabled for communications with the communications device in the cell.

Paragraph 17. Infrastructure equipment for use in a wireless communications network comprising a core network, the infrastructure equipment providing a wireless access interface, the infrastructure equipment comprising a transmitter configured to transmit signals to a communications device via the wireless access interface in a cell, a receiver configured to receive signals from the communications device, and a controller, configured to control the transmitter and the receiver so that the infrastructure equipment is operable: to determine whether one or more predetermined conditions associated with a security function are met by determining whether or not the security function is to be enabled for communications with the communications device in the cell, and if the one or more predetermined conditions are met, to transmit a security status indication to the core network, the security status indication indicating whether or not the security function is to be enabled for communications with the communications device in the cell.

Paragraph 18. Circuitry for an infrastructure equipment for use in a wireless communications network comprising a core network, the infrastructure equipment providing a wireless access interface, the circuitry comprising transmitter circuitry configured to transmit signals to a communications device via the wireless access interface in a cell, receiver circuitry configured to receive signals from the communications device, and controller circuitry, configured to control the transmitter circuitry and the receiver circuitry so that the infrastructure equipment is operable: to determine whether one or more predetermined conditions associated with a security function are met by determining whether or not the security function is to be enabled for communications with the communications device in the cell, and if the one or more predetermined conditions are met, to transmit a security status indication to the core network, the security status indication indicating whether or not the security function is to be enabled for communications with the communications device in the cell.

Paragraph 19. A method according to any of paragraphs 1 to 18, wherein the one or more predetermined conditions comprises a condition that the security function is to be enabled for the communications with the communications device in the cell.

Paragraph 20. A method according to any of paragraphs 1 to 18, wherein the one or more predetermined conditions comprises a condition that the security function is to be disabled for the communications with the communications device in the cell.

Paragraph 21. A method according to any of paragraphs 1 to 20, wherein the one or more predetermined conditions comprises a condition that the communications are associated with a signalling radio bearer.

Paragraph 22. A method of controlling communications by a core network of a wireless communications network, the wireless communications network comprising the core network, an infrastructure equipment providing a wireless access interface in a cell for transmitting and receiving data to and from a communications device, the method comprising receiving a security status indication, the security status indication indicating whether a security function is to be enabled for the communications with the communications device, and in response to receiving the security status indication, determining whether enabling or disabling the security function in accordance with the security status indication is permitted in respect of the communications with the communications device in the cell.

Paragraph 23. A method according to paragraph 22, wherein determining whether enabling or disabling the security function in accordance with the security status indication is permitted in respect of the communications with the communications device in the cell comprises determining whether the communications with the communications device are subject to a second security function provided by an application and if the communications with the communications device are subject to the second security function provided by an application, determining that the security function is not required to be applied to the communications with the communications device in the cell.

Paragraph 24. A method according to paragraph 22 or paragraph 23, wherein the security status indication indicates that the security function is not to be enabled for the communications with the communications device, the method comprising determining that the security function is required to be applied to the communications with the communications device in the cell, and in response to determining that the security function is required to be applied to the communications with the communications device in the cell, performing an authentication procedure with the communications device.

Paragraph 25. A method according to paragraph 22 or paragraph 23, wherein receiving the security status indication comprises receiving the security status indication from the communications device.

Paragraph 26. A method according to paragraph 22 or paragraph 23, wherein receiving the security status indication comprises receiving the security status indication from the infrastructure equipment.

Paragraph 27. A method according to paragraph 26, the method comprising receiving a path switch message indicating that the infrastructure equipment is requesting to be associated with the communications device as a result of a handover, the path switch message comprising the security status indication.

Paragraph 28. A method according to any of paragraphs 22 to 27, the method comprising before receiving a security status indication, transmitting a configuration indication to the communications device, the configuration indication indicating that the communications device is to determine whether one or more predetermined conditions associated with the security function are met.

Paragraph 29. Core network equipment for use in a wireless communications network, the wireless communications network comprising the core network equipment, an infrastructure equipment providing a wireless access interface in a cell for transmitting and receiving data to and from a communications device, the core network equipment comprising a transmitter configured to transmit signals to the infrastructure equipment, a receiver configured to receive signals from the infrastructure equipment, and a controller, configured to control the transmitter and the receiver so that the core network equipment is operable: to receive a security status indication, the security status indication indicating whether a security function is to be enabled for communications with the communications device, and in response to receiving the security status indication, to determine whether enabling or disabling the security function in accordance with the security status indication is permitted in respect of the communications with the communications device in the cell.

Paragraph 30. Circuitry for core network equipment for use in a wireless communications network, the wireless communications network comprising the core network equipment, an infrastructure equipment providing a wireless access interface in a cell for transmitting and receiving data to and from a communications device, the core network equipment comprising transmitter circuitry configured to transmit signals to the infrastructure equipment, a receiver circuitry configured to receive signals from the infrastructure equipment, and controller circuitry configured to control the transmitter circuitry and the receiver circuitry so that the core network equipment is operable: to receive a security status indication, the security status indication indicating whether a security function is to be enabled for communications with the communications device, and in response to receiving the security status indication, to determine whether enabling or disabling the security function in accordance with the security status indication is permitted in respect of the communications with the communications device in the cell.

Paragraph 31. A method according to any of paragraphs 1 to 30, wherein the security function is an access stratum security function which provides one or more of confidentiality and integrity protection for the communications between the communications device and the infrastructure equipment.

Paragraph 32. A method according to any of paragraphs 1 to 31, wherein it is permitted to disable the security function for at least some communications with one or more communications devices in the wireless communications network.

Further particular and preferred aspects of the present invention are set out in the accompanying independent and dependent claims. It will be appreciated that features of the dependent claims may be combined with features of the independent claims in combinations other than those explicitly set out in the claims.

### REFERENCES

[1] 3GPP TS 38.300 v. 15.2.0 “NR; NR and NG-RAN Overall Description; Stage 2 (Release 15)”, June 2018
[2] Holma H. and Toskala A, “LTE for UMTS OFDMA and SC-FDMA based radio access”, John Wiley and Sons, 2009
[3] 3GPP TR 38.913, “Study on Scenarios and Requirements for Next Generation Access Technologies (Release 14)”.
[4] 3GPP TS 33.501 “Security architecture and procedures for 5G system (Release 15)”, version 15.2.0, September 2018

1. A method of communicating by a communications device in a wireless communications network, the wireless communications network comprising a core network, an infrastructure equipment providing a wireless access interface in a cell for transmitting and receiving data to and from the communications device, the method comprising
controlling the communicating by the communications device in the wireless communications network,
determining whether one or more predetermined conditions associated with a security function are met, wherein determining whether the one or more predetermined conditions are met comprises determining whether the security function is to be enabled for communications with the communications device in the cell, and
if the one or more predetermined conditions are met, transmitting a security status indication to the core network, the security status indication indicating whether the security function is to be enabled for communications with the communications device in the cell.

2. A method according to claim 1, wherein the cell is a target cell, the method comprising
receiving from a source infrastructure equipment providing a wireless access interface in a source cell a handover indication that the communications device is to change a serving cell from the source cell to the target cell, and
the determining whether one or more predetermined conditions associated with a security function are met is in response to receiving the handover indication.

3. A method according to claim 2, wherein the one or more predetermined conditions comprises a condition that the security function is enabled for the communications with the communications device in the source cell.

4. A method according to claim 1, wherein determining whether the security function is to be enabled for communications with the communications device in the cell comprises determining that the security function is to be disabled for the communications with the communications device in the cell, the method comprising
receiving from the core network a security function permission indicator, the security function permission indicator indicating that disabling the security function for the communications with the communications device in the cell is not permitted.

5. A method according to claim 4, the method comprising
in response to receiving the security function permission indicator, terminating a connection between the communications device and the infrastructure equipment.

6. A method according to claim 1, wherein the one or more predetermined conditions comprises a condition that the security function is currently enabled and the security function is to be disabled for the communications with the communications device.

7. A method according to claim 1, the method comprising
receiving a configuration indication transmitted by the infrastructure equipment, the configuration indication indicating that the communications device is to determine whether the one or more predetermined conditions associated with the security function are met,
wherein the determining whether one or more predetermined conditions associated with a security function are met is in response to receiving the configuration indication.

8. A method of communicating with a communications device in a wireless communications network, the wireless communications network comprising a core network, an infrastructure equipment providing a wireless access interface in a cell for transmitting and receiving data to and from the communications device, the method comprising
controlling the communicating by the communications device in the wireless communications network,
determining by the infrastructure equipment whether one or more predetermined conditions associated with a security function are met, wherein determining whether the one or more predetermined conditions are met comprises determining whether or not the security function is to be enabled for communications with the communications device in the cell, and
if the one or more predetermined conditions are met, transmitting a security status indication to the core network, the security status indication indicating whether or not the security function is to be enabled for communications with the communications device in the cell.

9. A method according to claim 8, wherein the cell is a target cell, the method comprising
receiving a handover request from a source infrastructure equipment providing a wireless access interface in a source cell, the handover request indicating that the communications device is to change a serving cell from the source cell to the target cell, and
wherein the determining whether the one or more predetermined conditions associated with the security function are met is in response to receiving the handover request indication.

10. A method according to claim 9, wherein the handover request indication comprises an indication of whether the security function is to be enabled for communications with the communications device in the target cell.

11. A method according to claim 10, the method comprising
establishing a connection with the communications device in the target cell, and
before transmitting to the core network the security status indication, enabling or disabling the security function in respect of the connection in accordance with the handover request indication.

12. A method according to claim 8, the method comprising
receiving from the core network a security function permission indicator, the security function permission indicator indicating that disabling the security function for the communications with the communications device in the cell is not permitted.

13. A method according to claim 12, the method comprising
in response to receiving the security function permission indicator, enabling the security function for the communications with the communications device in the cell.

14. A method according to claim 12, the method comprising
in response to receiving the security function permission indicator, terminating a connection between the communications device and the infrastructure equipment.

15. A communications device for use in a wireless communications network, the wireless communications network comprising an infrastructure equipment providing a wireless access interface and a core network, the communications device comprising
a transmitter configured to transmit signals via the wireless access interface,
a receiver configured to receive signals, and
a controller configured to control the transmitter and the receiver so that the communications device is operable:
to determine whether one or more predetermined conditions associated with a security function are met by determining whether the security function is to be enabled for communications with the communications device in the cell, and
if the one or more predetermined conditions are met, to transmit a security status indication to the core network, the security status indication indicating whether the security function is to be enabled for communications with the communications device in the cell.

16. (canceled)

17. Infrastructure equipment for use in a wireless communications network comprising a core network, the infrastructure equipment providing a wireless access interface, the infrastructure equipment comprising
a transmitter configured to transmit signals to a communications device via the wireless access interface in a cell,
a receiver configured to receive signals from the communications device, and
a controller, configured to control the transmitter and the receiver so that the infrastructure equipment is operable:
to determine whether one or more predetermined conditions associated with a security function are met by determining whether or not the security function is to be enabled for communications with the communications device in the cell, and
if the one or more predetermined conditions are met, to transmit a security status indication to the core network, the security status indication indicating whether or not the security function is to be enabled for communications with the communications device in the cell.

18.-32. (canceled)
